(19) United States
(12) Patent Application Publication
(10) Pub. No.: US 2011/0232046 A1
(43) Pub. Date: Sep. 29, 2011

(54) BANKNOTE ADAPTED TO FORM A MAGNETIC MONEY CLIP

(76) Inventor: Scott L. Amron, Smithtown, NY (US)

(21) Appl. No.: 13/037,664

(22) Filed: Mar. 1, 2011

Related U.S. Application Data
(63) Continuation-in-part of application No. 12/578,087, filed on Oct. 13, 2009.
(60) Provisional application No. 61/196,006, filed on Oct. 14, 2008.

(51) Int. Cl. A45C 1/00; H01F 7/02

(52) U.S. Cl. 24/303

(57) ABSTRACT

A magnetic clip is provided having two magnetic components to create a low-cost, thin, soft magnetic vise- like mechanism. The magnetic components are disposed in individual stickers or a unitary sticker. The clip includes an adhesive layer to which a real banknote may be removably attached. The user can simply peel back the banknote to open the magnetic vise-like mechanism to insert or remove one or more banknotes. The user then folds the substrate back onto itself to close and secure the remaining banknote(s).

### CROSS REFERENCE TO RELATED APPLICATIONS

This application is a Continuation-in-Part of U.S. Ser. No. 12/578,087, entitled “A BANKNOTE ADAPTED TO FORM A MAGNETIC MONEY CLIP which is based on and claims priority to Provisional application Ser. No. 61/196,006, filed Oct. 14, 2008 and entitled” A BANKNOTE ADAPTED TO FORM A MAGNETIC MONEY CLIP.” The respective entire disclosures of the above noted applications are incorporated by reference herein.

### BACKGROUND OF THE INVENTION

1. Field of the Invention

The present invention relates to a magnetic clip employing a connective substrate linking two or more magnetic components to provide a unique and intuitive money clipping utility.

2. Background

Magnetic money clips are used to keep paper money organized within a magnetic vise-like mechanism, offering a greater carrying capacity than that of a stiff and unforgiving metal money clip. Conventional money clips are generally comprised of one or more bulky leather substrates sized substantially smaller than the banknotes it is designed to hold. Magnetic components are placed at opposing ends of the substrate(s). The substrate is then folded at its center to create a vise- like clipping mechanism thereby doubling the device's profile. Small bulky magnetic money clips are awkward to handle and do not fit well in tight pockets. Current magnetic money clip assemblies fail to provide the user with an inexpensive, thin, soft, pliable, low-profile, easy- to-grab, and forgiving means of keeping paper money organized on-the-go.

### SUMMARY OF THE INVENTION

It is a general object of the present invention to provide a magnetic money clip that avoids the drawbacks of prior magnetic money clips.

More, specifically, it is an object of the present invention to provide a magnetic money clip that is an inexpensive, thin, soft, pliable, low-profile, easy-to-grab, and a forgiving means of keeping paper money on-the-go.

These and other objects of the invention are achieved by a magnetic clip comprising a substrate and a coupled set of magnetic components. Means are provided to secure the magnetic components to the substrate.

In accordance with one aspect of the invention, a magnetic clip is provided having a connective paper substrate possessing the same size, shape and feel of a real banknote to provide a unique and intuitive money clipping utility. Two magnetically paired stickers are affixed to the paper substrate. Alternatively, the magnetic components may be embodied in a unitary structure.

Employing a real banknote as a connective paper substrate adds to the minimalist appeal. That is, the idea of clipping money with money and disguising the money clip as a banknote offers additional value as a novelty. The money clipping mechanism essentially disappears into the wad of cash, creating a bankroll that appears well-behaved without additional apparatus. The use of a real banknote as the paper substrate also provides the device with improved durability and mechanical performance over current magnetic money clips. Banknote paper is known to for its strength and durability. Its formula is considered a governmental secret. Although, banknote paper is more durable than paper found in the public domain, the current invention can be realized by employing alternative paper with mechanical characteristics similar to that of banknote paper.

Alternatively, the embodiment utilizing a unitary sticker may be folded in the opposite direction to expose the sticker which may have advertising, logos, or the like on its outer, exposed surface.

As used herein, the term “magnetic components” shall refer to any and all materials that possess magnetic properties including carbon steel, all materials that contain iron and non-metallic magnets made from organic polymers such as PANiCNQ, which is a combination of emeraldine-based polyaniline (PANi) and tetracyanoquinodimethane (TCNQ).

### BRIEF DESCRIPTION OF THE DRAWINGS

The various features, functions and advantages characterizing the invention will be better understood by reference to the detailed description which follows, taken in conjunction with the accompanying drawings. It should be understood that the drawings are not necessarily drawn to scale and that, unless otherwise indicated, they are merely intended to conceptually illustrate the structures and procedures described herein. In the drawings, wherein like reference characters denote similar elements throughout the several views:

FIG. 1 is a front plan view of one of two magnetically paired stickers constructed in accordance with an illustrative embodiment of the present invention;

FIG. 2 is a side view of the magnetic sticker of FIG. 1;

FIG. 3 is a longitudinal elevational view of the magnetic sticker of FIG. 1;

FIG. 4 is perspective view of the top of one of two magnetically paired stickers constructed in accordance with an illustrative embodiment of the present invention;

FIG. 5 is an exploded perspective view of the bottom of one of two magnetically paired stickers constructed in accordance with an illustrative embodiment of the present invention;

FIG. 6 is a plan view of two magnetically paired stickers affixed to a ONE-dollar bill;

FIG. 7 is a plan view of the ONE dollar bill with magnetic stickers of FIG. 4 folded to create a magnetic money clip;

FIGS. 8-11 are elevation views of magnetically paired stickers attached to a paper substrate illustrating various configurations of magnetic components;

FIG. 12 is an exploded perspective view of a unitary magnetic sticker constructed in accordance with an alternative embodiment of the present invention;

FIG. 13 is an exploded perspective view of a variant of the unitary magnetic sticker shown in

FIG. 14 is a plan view of the unitary sticker of FIG. 13; and

FIG. 15 depicts plan views of three exemplary shapes of unitary magnetic stickers constructed in accordance with the method of assembly illustrated in FIG. 13.

### DETAILED DESCRIPTION OF THE INVENTION

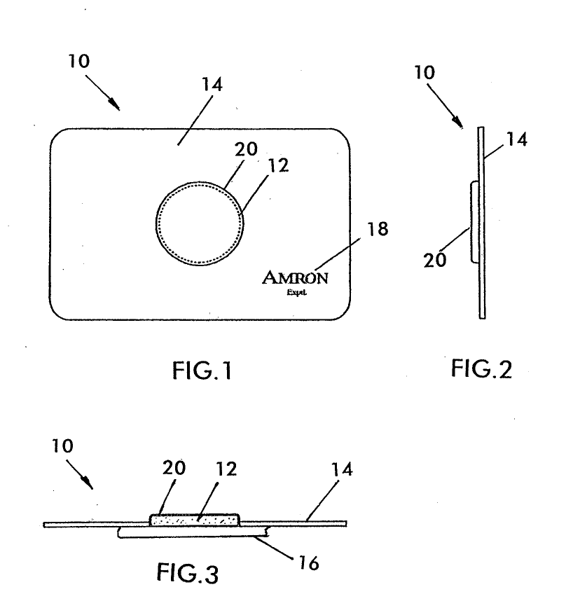

Referring now to the drawings and, in particular, to FIGS. 1-5, there is shown one of two magnetically paired stickers 10 constructed in accordance with the preferred embodiment of the present invention. The magnetic sticker 10 contains a neodymium disc magnet 12 measuring 0.8 mm thick and 12 mm in diameter embedded in a fabric reinforced label 14 having a pressure sensitive adhesive backing 16. The label 14 has been die-cut to shape and embossed to create a corporate logo 18 and cavity 20 in which the magnet 12 sits.

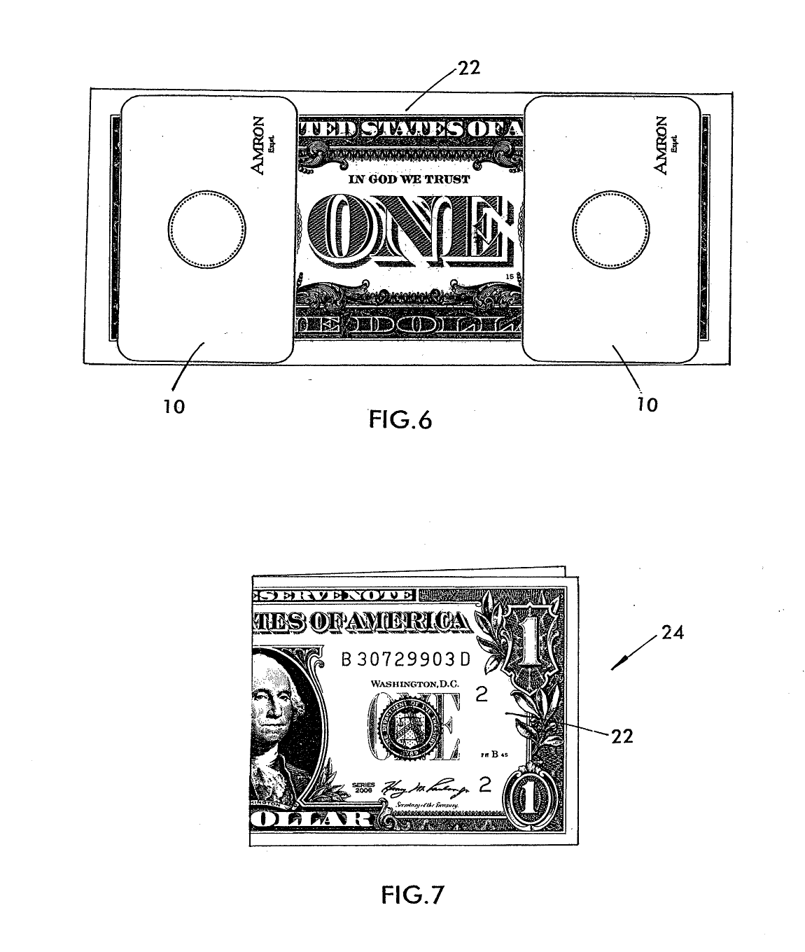

Referring to FIG. 6, two of the magnetically paired stickers 10 are attached to a substrate, which, in a preferred embodiment, is a real paper banknote, such as a ONE-dollar bill 22. In the case where the substrate is a banknote, such as the bill 22, the adhesive backing 16 is of a type such that the stickers 10 may be removed from the bill 22 without any damage thereto. An appropriate adhesive is duct tape. An appropriate epoxy may also be used.

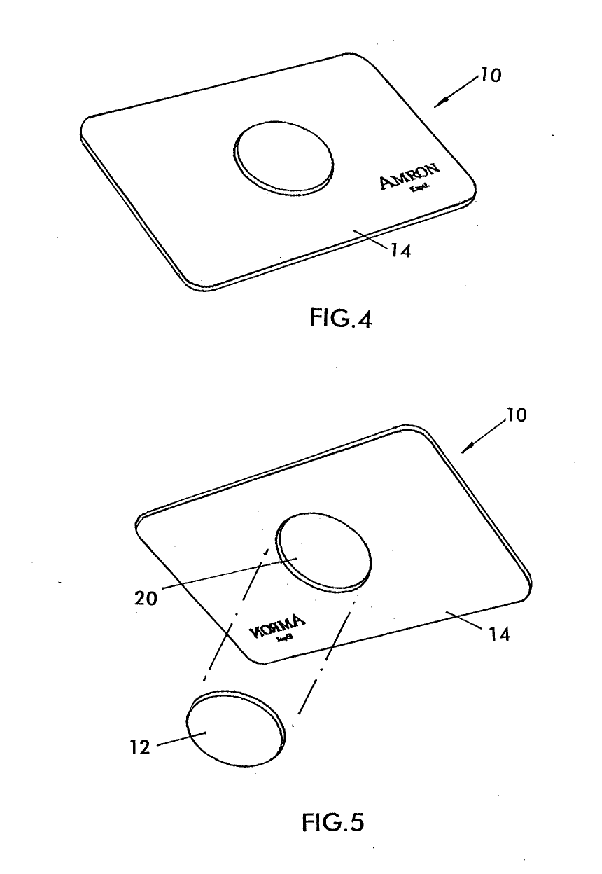

FIG. 7 shows the dollar bill 22 (and stickers) of FIG. 4 folded at its center to create a magnetic money clip 24 with magnetic vise-like mechanism. Banknotes can be placed between the folded magnetic ends. The user can easily peel back the dollar bill substrate 22 when removing the secured banknotes. The user can handle the magnetic clip 24 as if it were any other dollar bill in the wad of cash.

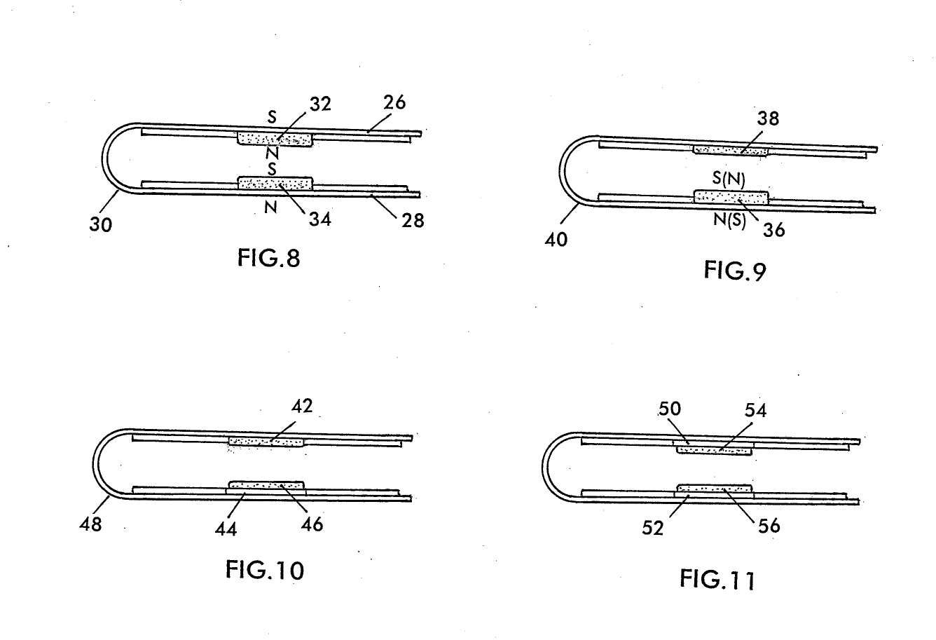

FIG. 8 shows two magnetically paired stickers 26 and 28 attached to a paper substrate 30. The stickers 26 and 28 contain magnets 32 and 34, respectively. The magnets 32 and 34 are oriented with opposite poles facing inward (NS or SN) to create the attractive vise-like magnetic mechanism. This configuration offers a self centering feature as the two magnets 32 and 34 center themselves on each other to give a perfectly symmetric close every time even when carelessly flipped.

FIG. 9 shows one magnet 36 that can be oriented with either its North or South face exposed to a steel plate 38 of the opposing end of the paper substrate 40. In this configuration both the magnet 36 and the steel plate 38 act as “magnetic components.” This configuration offers the lowest cost to manufacture. It does not provide the self-centering feature offered by the configuration in FIG. 8. It does however substantially cap the magnet's magnetic field, as the magnetic field of the magnet 36 does not penetrate through the steel plate 38 in the closed position.

FIG. 10 shows two (2) steel plates 42 and 44 arranged to cap the magnetic field of a magnet 46 when the device is in the closed position. The magnet 46 is attracted to the steel plate 42 attached to the opposite end of the paper substrate 48. The steel plate 44 effectively strengthens magnet 46 by focusing its magnetic field in the direction of steel plate 42 on the opposite end of the paper substrate 48. This configuration offers a magnetic field capping function in both directions when in the closed position. But, it does not feature the self-centering effect had by the configuration shown in FIG. 8.

FIG. 11 shows two (2) steel plates 50 and 52 arranged to cap the magnetic fields of two magnets 54 and 56 when in the closed position. The magnets 54 and 56 are oriented with opposite poles facing inward (either NS or SN). This configuration offers both the bi-directional magnetic field capping feature had by the configuration of FIG. 10 and the self-centering feature had by FIG. 8.

Among the advantages and features of the foregoing embodiment, in addition to those already noted, are the following:
1. The magnetic money clip has the same size and feel as the cash it holds;
2. One could potentially use the money clip as currency when low on cash as the stickers are removable with no harm to the banknote;
3. The banknote may be of any denomination (e.g., 5, 10,20,50, and $100);
4. Subject to compliance with the laws of the EEC, can be made from Euro banknotes to hold Euro banknotes;
5. Prevents lower back pain caused by bulky wallets and bulky magnetic money clips;
6. Subject to compliance with the laws of the issuing country, obsolete paper currency such as the lire can be used as the paper substrate; and
7. Can be sold as a DIY (Do It Yourself) kit (with two magnetically paired stickers) or as an assembled magnetic money clip (a dollar bill with the two stickers already attached).

It should be noted that the use of banknotes as substrates in accordance with the present invention is subject to the laws of the country issuing the currency. For example, in the United States according to present law, it is illegal to deface currency in such a way that it is made unfit for circulation (Title 18, Section 333 of the United States Code). Since the present invention uses an adhesive that allows the bill to be removed without any damage, the bill is fit for circulation and, therefore, use of the invention with a U.S banknote fully complies with U.S. law.

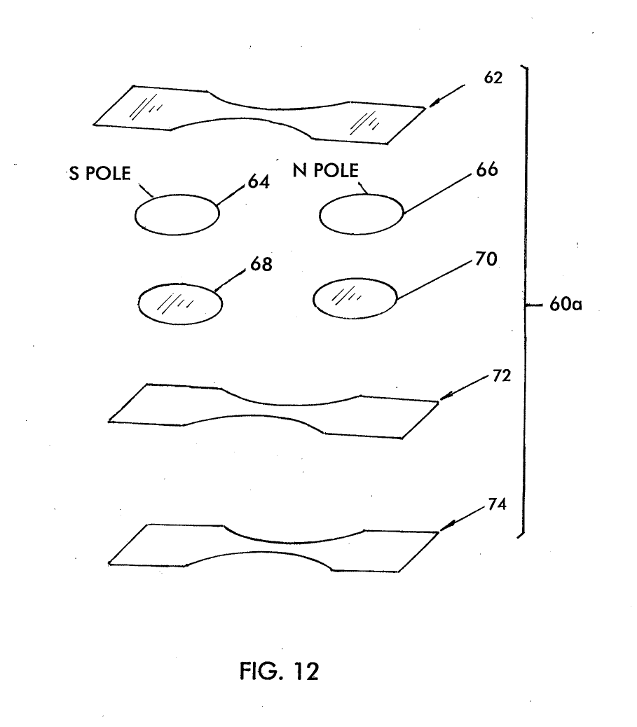

An alternative to the use of two separate labels to form a money clip sticker is an embodiment in which the magnets are incorporated in a unitary structure. Referring to FIG. 12, a unitary money clip sticker 60a may be formed as follows:
a) A support substrate 62 of plastic, such as vinyl, leatherette, leather, plastic or any similar durable material;
b) two disc magnets 64 and 66 which have axially and oppositely magnetized poles on their flat faces and which may be neodymium magnets;
c) two steel shielding discs or plates 68 and 70;
d) Optional step down rings to facilitate assembly of the shielding plates and magnetic discs to the support substrate;
e) a sheet 72 of double sided adhesive which may be a watergel adhesive; and
f) a removable paper liner 74 which may be wax paper.

In use, the paper liner 74 is removed and a banknote removably attached to the liner, thereby forming a money clip similar to the separate label embodiment shown in FIGS. 1-11. Then the money clip is used in the same manner as the money clip of the separate label embodiment, that is, the money clip is folded such that the attached banknote overlies the money clip sticker 60a with the money clip sticker 60a being hidden.

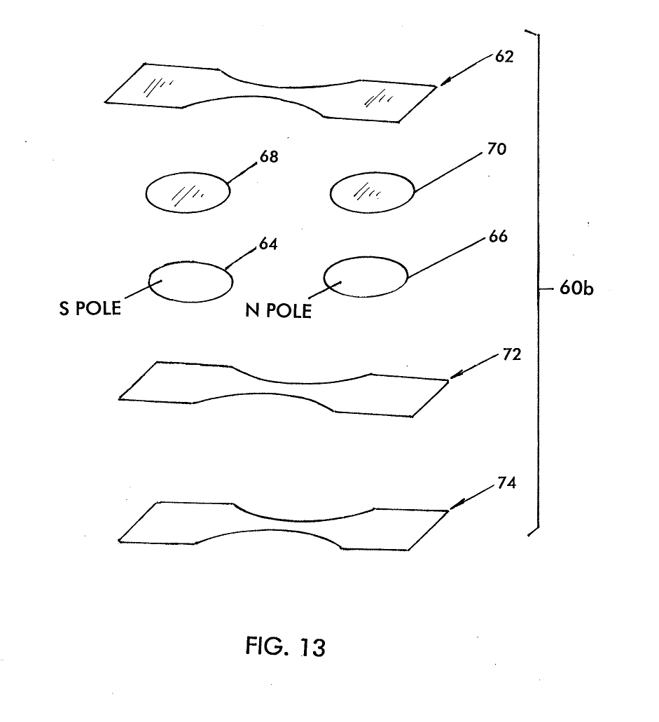

Alternatively, the money clip sticker may be folded in the opposite manner such that the money clip sticker is on top. In this case, it is advantageous to reverse the order of the magnetic discs 64 and 66 and steel sheets 68 and 70, as shown in FIG. 13 in the case of the magnetic sticker 60b. Reversing the order of the magnetic discs 64 and 66 and steel sheets 68 and 70 assures that the facing magnetic discs are unshielded when the sticker is on top.

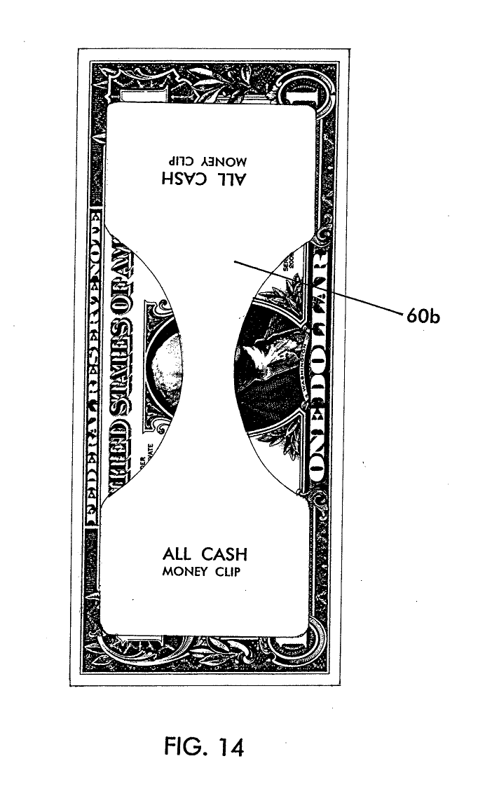

One of the advantages of having the sticker 60b on top allows corporate logos, advertising or other messages to be placed on the outer surface by printing, decals or any other suitable means, as shown in FIG. 14.

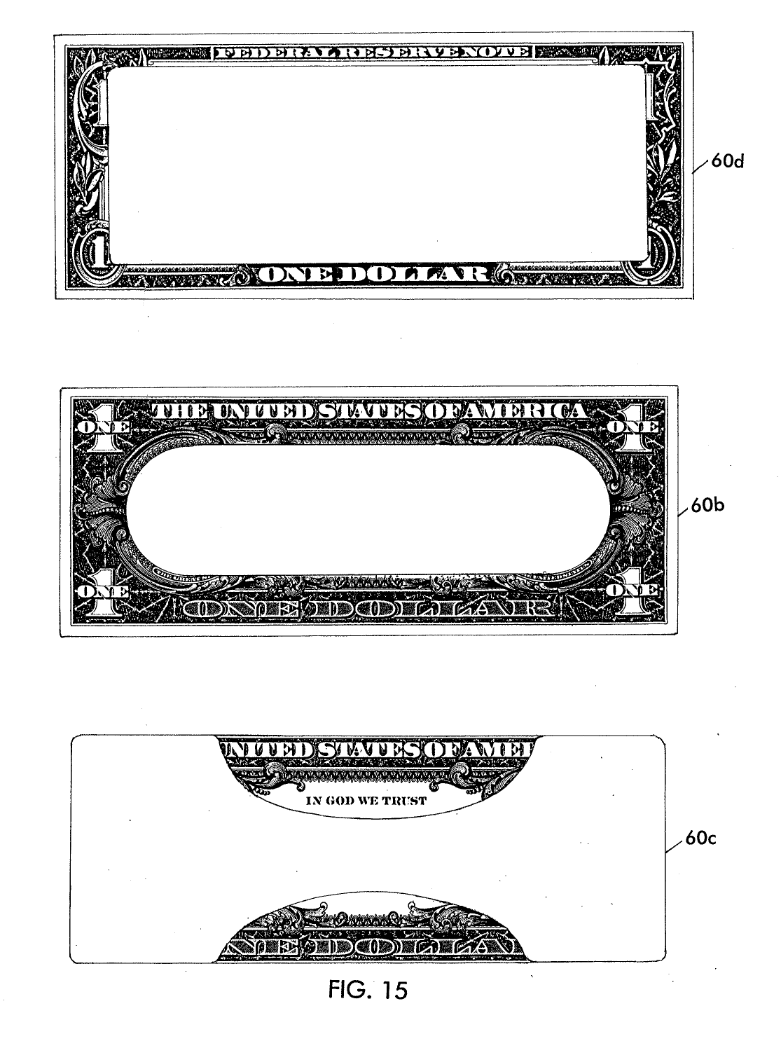

The sticker may have many different shapes. See, for examples, the stickers 60b, 60c and 60d of FIG. 15. The sticker also may be of any color. Further, as should be apparent, the sticker may also be used as a money clip without first attaching it to a banknote.

While this invention has been illustrated and described in accordance with preferred embodiments of the present invention, it is recognized that variations and changes may be made therein. Thus, for example, while the illustrative embodiments shown and described herein have employed a real one-dollar bill as the paper substrate, a substrate made of ordinary paper is within the scope of the present invention. It is also possible to attach the magnetic components between two sheets of paper (two paper substrates) or two banknotes. Also, while the magnetic clip has been described as preferably being used as a money clip, it should be understood that its use is not so limited and that it may be used as a clip for anything.

What is claimed is:

1. The magnetic clip comprising:
a substrate;
a pair of magnetic components; and
means to secure the magnetic components to the substrate at spaced locations.

2. The magnetic clip according to claim 1, wherein the securing means removably attach the magnetic components to the substrate.

3. The magnetic clip according to claim 1, wherein the securing means fixedly attaches the magnetic components to the substrate.

4. The magnetic clip according to claim 2, wherein the substrate is a real paper banknote and the securing means are removable with no harm to the substrate.

5. The magnetic clip according to claim 2, wherein the pair of magnetic components comprises two neodymium disc magnets.

6. The magnetic clip according to claim 2, wherein each magnetic component comprises one magnet and one plate of steel.

7. The magnetic clip according to claim 2, wherein each magnet comprises a neodymium disc magnet and a steel plate.

8. The magnetic clip according to claim 2, wherein each magnetic component comprises one neodymium disc magnet and two thin plates of carbon steel arranged in such a way so as to have the two steel plates cap the magnet.

9. A magnetic clip sticker comprising:
a first substrate;
a pair of magnetic components; and
means including a second substrate to secure the magnetic components between the substrates at spaced locations.

10. The magnetic clip according to claim 9, wherein each of the substrates has an upper surface and a lower surface and the magnetic components are disposed between the lower surface of the first substrate and the upper surface of the second substrate.

11. The magnetic clip according to claim 10, wherein each magnetic component comprises one magnet and one plate of steel.

12. The magnetic clip according to claim 10, wherein the magnet and steel plate of each magnetic components are arranged in tandem.

13. The magnetic clip according to claim 10, wherein the magnet and steel plate of each magnetic components are arranged in tandem with the magnet being disposed adjacent the first substrate and the metal plate being behind the magnet.

14. The magnetic clip according to claim 10, wherein the magnet and steel plate of each magnetic components are arranged in tandem with the steel plate disposed adjacent the first substrate and the magnet being behind the steel plate.

15. The magnetic clip according to claim 13, wherein the lower surface of the second substrate has an adhesive layer.

16. The magnetic clip according to claim 15, wherein a real paper banknote is removably attached to the adhesive layer.

17. The magnetic clip according to claim 14, wherein the lower surface of the second substrate has an adhesive layer.

18. The magnetic clip according to claim 17, wherein a real paper banknote is removably attached to the adhesive layer.

19. A magnetic money clip comprising:
a paper substrate;
a pair of fabric carriers;
a set of magnetic components held respectively by the pair of fabric carriers; and
means to secure the pair of fabric carriers to the substrate at spaced locations.

20. A kit for forming a magnetic money clip, comprising:
a set of magnetic components; and
a pair of fabric carriers for respectively receiving and holding the set of magnetic components.

21. A kit for forming a magnetic money clip according to claim 20, further comprising means for attaching the fabric carriers to a paper substrate at spaced locations to form the money clip.
